(19) United States
(12) Patent Application Publication
(10) Pub. No.: US 2015/0102677 A1
(43) Pub. Date: Apr. 16, 2015

(54) System and Method for Using Capacitors in Remote Operations

(71) Applicant: Battery-Free Outdoors, LLC, Austin, TX (US)

(72) Inventors: William P. Laceky, Georgetown, TX (US); Marty Akins, Austin, TX (US); William Bryant, Austin, TX (US); Bryan Lee, Austin, TX (US)

(21) Appl. No.: 14/512,233

(22) Filed: Oct. 10, 2014

Related U.S. Application Data
(63) Continuation of application No. 13/352,975, filed on Jan. 18, 2012, now abandoned.
(60) Provisional application No. 61/433,833, filed on Jan. 18, 2011.

(51) Int. Cl. H02J 7/34; H02J 7/35; H02J 1/10

(52) U.S. Cl. CPC H02J 7/345; H02J 1/10; H02J 7/35
USPC 307/65

(57) ABSTRACT

A battery-free device is provided with one or more series or parallel capacitive networks. One or more solar panels are used to charge the capacitive networks and one or more charging circuits are used to control the charging of the capacitive networks. One or more DC-DC converters maybe used to provide a voltage to the device, a remote monitoring or controlling function, and, optionally, a user interface. In those instances when it is desired that the monitoring or controlling function remain powered at all times, the control circuitry is preferentially preserved at the expense of the other features of the device such that if, for any reason, the capacitive network is drained after running the other features, there will still be sufficient power stored in capacitive network to maintain the monitoring or controlling function.

### PRIORITY STATEMENT

### Under 35 U.S.C. §119 & 37 C.F.R. §1.78

This non-provisional application claims priority based upon prior U.S. Provisional Patent Application Ser. No. 61/433,833 filed Jan. 18, 2011 in the name of William P. Laceky, Marty Akins. William Bryant and Bryan Lee entitled “Battery-Free Methods and Systems,” the disclosure of which is incorporated herein in its entirety by reference as if fully set forth herein.

### BACKGROUND OF THE INVENTION

There are an extremely wide variety of products used or useful that utilize batteries or solar cells/solar panels or a combination of both batteries and solar panels to power the products and that also require remote monitoring. However, in many cases, the batteries are a major cause of failure and maintenance, thereby causing not only the device to stop working but also results in a loss of power to the monitoring capability. A product that uses only batteries without a solar charging device will require the end user to periodically charge or change the battery. Even batteries charged by solar cells or solar panels will require user maintenance due to the inherent limitations of batteries that cause the battery to degrade and fail over time, in addition to the influence of many other factors such as temperature, charge rate, depth of discharge, vibration, etc. Depending on the duty of the product, the user may have to recharge the battery anywhere from daily to yearly. A device that uses solar cells/solar panels along with batteries typically requires less maintenance since the solar energy is used to charge the batteries during the day and the batteries power the electrical circuit at night. This cycle helps keep the battery from completely discharging, reducing user charging or changing maintenance. However, the physical properties of batteries are such that the battery is typically limited to several hundred recharging cycles. Moreover, the number of recharging cycles is negatively affected by variations of the ambient temperature surrounding the batteries. Since these products are designed for use in an outdoor environment where the batteries are exposed to extreme cold and hot conditions, the batteries typically reach an early end of life ranging from days to several years depending on their usage and environmental surroundings.

The present invention provides several advantages over the prior art including: a longer life compared to systems that rely on rechargeable batteries; the reduction or elimination of battery maintenance; a lighter weight system; superior temperature tolerance; almost unlimited use (charging and discharging); and a system that is more environmentally friendly than battery-based systems.

Those skilled in the art can readily determine the voltage at given points in time during the discharging or charging of the capacitors. The capacitors would be discharging due to the load presented by the products function being powered by the capacitors. The capacitors can be charging under various conditions and circumstances depending on the product's intended function, design, type of charging, power source, and how much charging energy is available from the source at any given time. (an example of capacitor discharging would be power required from the capacitor(s) to power the control circuitry of the device). To maximize the energy stored in these capacitors, a DC to DC converter can be used to step the capacitor voltage up or down to obtain a steady power supply for the device as the capacitor voltages drop. For example, a DC to DC charge-pump or switch-mode circuit could be used to convert the 6V capacitor voltage to 6V DC even as the capacitor voltage falls below 6 volts. This provides the maximum amount of energy from the capacitors to be used for powering the device circuits, allowing the designer to minimize the number of capacitors used in the design while maintaining the appropriate duration of available power between re-charges from the solar panel.

### SUMMARY OF THE INVENTION

According to one aspect of the invention, a battery-free device is adapted with one or more series or parallel capacitive networks. One or more solar panels are used to charge the capacitive networks and one or more charging circuits are used to control the charging of the capacitive networks. One or more DC-DC converters maybe used to provide a voltage to a device. In those instances when it is desired that connectivity functionality remain powered at all times, the connectivity functionality is preferentially preserved at the expense of the other features of the device such that if, for any reason, the capacitive network is drained after running the other features, there will still be sufficient power stored in capacitive network to maintain the connectivity functionality.

The foregoing has outlined rather broadly certain aspects of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The present invention is illustrated by way of example and not limitation in the figures of the accompanying drawings, in which like references indicate similar elements and in which:

FIG. 1 is a block diagram showing a basic depiction of a system using capacitive energy storage in place of battery energy storage;

FIG. 2 is a block diagram of an system used to power a device with remote connectivity of the present invention;

FIG. 3 is a block diagram of an example of a device using capacitive energy storage;

FIG. 4 is a block diagram showing another embodiment of a system for powering a device of the present invention:

FIG. 5 is a block diagram illustrating circuitry for powering a device and for powering other circuitry using energy stored in capacitive networks:

FIGS. 6 and 7 are block diagrams illustrating other embodiments of the present invention; and

FIG. 8 is a block diagram of another example of a system for powering device using capacitive energy storage.

### DETAILED DESCRIPTION OF THE INVENTION

The present invention contemplates systems powered by energy stored in capacitors. For example, a system may include a device that draws power from one or more capacitors. In this example, energy stored in the capacitors comes from one or more power supplies. If desired, the system can be operated without batteries, which may increase the reliability and life span of the system. The present invention may be used with any desired device that requires a power source for providing power to a power dissipating device. The invention may be used for applications beyond those set forth in this application, as persons of ordinary skill in the art who have the benefit of the description of the invention will understand.

The present invention includes a power storage module using one or more capacitors to store energy. As discussed above, one of the problems with prior art systems is that batteries fail in a relatively short amount of time and require more difficult recharging efforts. The power storage module of the present invention solves this problem with the introduction of capacitive storage. The capacitors used in this invention have a much longer life expectancy than batteries and are much easier to charge. Thus, this invention requires a smaller and less expensive solar panel than other comparable battery operated and solar charged devices. Also, the capacitors can be discharged completely without any negative effect, whereas batteries typically cannot be discharged below 80% of their capacity without damage.

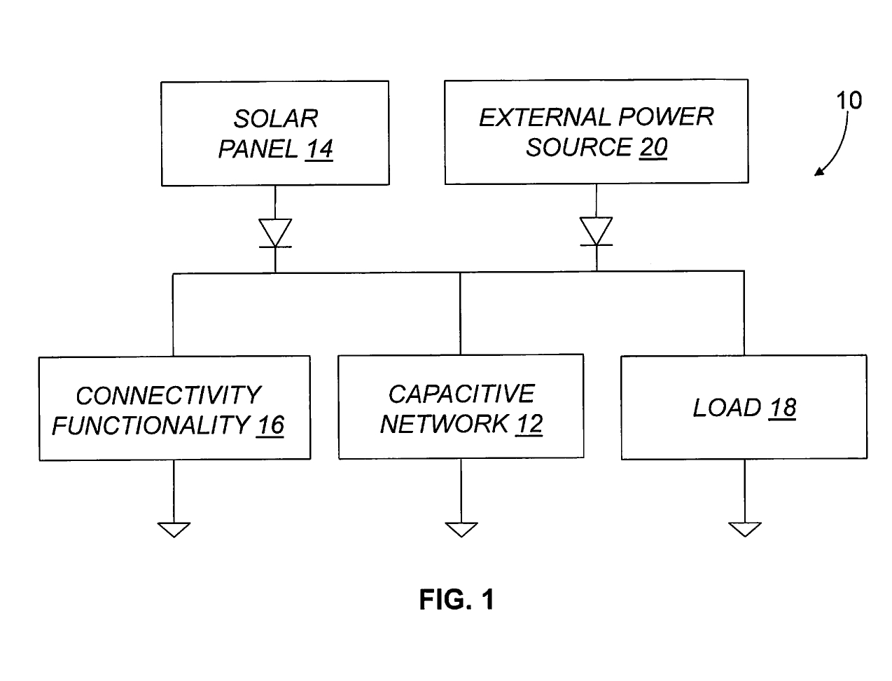

FIG. 1 is a basic depiction of a system 10 using capacitive energy storage in place of battery energy storage. FIG. 1 shows a capacitive network 12, which is coupled to solar panel 14. The capacitive network may be comprised of a single capacitor or multiple capacitors. Multiple capacitors could be placed in series, parallel, or in a series-parallel configuration. These configurations could exist as a single configuration or as multiple configurations depending on the voltage and current requirements of the operating circuit. FIG. 1 also shows connectivity functionality 16 and a load 18 coupled to the capacitive network 12 and solar panel 14. The connectivity functionality 16 may include circuitry to aid in the remote monitoring of the load, as well as circuitry to control the charging and discharging of the capacitive network 12. While connectivity functionality 16 is depicted separately in this Figure and other Figures, connectivity functionality 16 may be an integral part of the load, such as an embedded chip on a circuit board, may be a standalone module, such as an RF transceiver, or may be a separate device, such as a smart phone tethered to the load.

Capacitor technology using high dielectric films such as, but not limited to “Aerogel” allow large amounts of energy storage to exist in relatively small packages. Capacitors have a much greater (almost infinite) number of charge and discharge cycles compared to batteries. Capacitors are also far less affected by temperature. Using the concepts taught by the present invention, the density of the energy storage of capacitors allows adequate energy storage in capacitor form to replace batteries in many devices. Given the longer life properties of capacitors, devices using capacitors instead of batteries dramatically reduce required user maintenance. The devices contemplated herein use capacitors in place of batteries along with an adequate power supply, such as solar cells/solar panels, to repeatedly charge the capacitors during the day so they can be left unattended for years without maintenance.

While a person skilled in the art could utilize numerous storage modules using capacitors, following are some general guidelines for using capacitors in the products contemplated herein. Typically, capacitors have a working voltage that should not be exceeded. Capacitors also have an internal series resistance that may be taken into account along with the current demand that will be put on them. Capacitors can be connected in series to increase the stored voltage capability of the network. A series connection comes at the expense of decreasing the capacitance (Farads) of the network. Capacitors, or series strings of capacitors, can be connected in parallel to increase the capacitance value of the overall network. It may be necessary to balance the capacitors in series or in a series/parallel combination to, among other things, counteract the effects of variance in capacitance and leakage current and protect the capacitors from overvoltage. Balancing capacitors in series can be done in several ways, for instance, passively or actively. Passively, requires an appropriate sized load be placed permanently in parallel with each capacitor to be balanced. Placing a resistor across each capacitor would be a passive way to keep the voltages balanced reasonably equally from one capacitor to another. However, this method does not protect well against overvoltage of the capacitors. This method also presents a load to the circuit which continuously drains the capacitors. In most cases this is undesirable. In some applications, it may be desirable or imperative to provide balancing and overvoltage protection that is much faster and more accurate than passive methods. In this case active control is necessary. This can be done in several ways. One method but certainly not the only method would be to sense the voltage across each capacitor individually, then making a logical decision as to whether the voltage is too high or too low or in an acceptable range. In this example, a load can be turned ON or OFF in parallel with the capacitor of interest. Turning ON a parallel load allows energy to be drained out of the capacitor. Turning OFF the load allows the capacitor to continue to build charge. The parallel load can be adjusted by design to create an appropriately sized load to achieve the balance required within a specific amount of time. The ability to turn this load ON/OFF conserves energy until excess energy is present, making it a very efficient method to balance and maintain voltage levels across individual capacitors in a series or series/parallel string.

It is important to note that one cannot simply replace a battery with a capacitor and be able to effectively operate most battery operated products. Capacitors have many differences that require technology advances and significant engineering skills and design work to effectively use them in place of batteries.

One significant difference between batteries and capacitors is their energy densities and discharge characteristics. Batteries typically have a flat voltage level as they discharge to the end of their capacity. Capacitors have a different discharge profile, where the voltage falls quickly at first then slowing as it is discharged to the end of its capacity. So, for example, a 6V battery used to run a 6V motor in a device will provide a good steady 6V to the device through most of its charge without any additional help. On the other hand, a capacitor or combination of capacitors charged to 6V running the same device will quickly fall to 4V, then 2V, then 1V, etc., as it reaches the end of its charge. A 6V motor, for example, will not run very well, if at all, with these low voltages. The circuitry of the present invention overcomes these problems, allowing the device to run on capacitors.

Energy density also presents a major challenge when trying to replace batteries with capacitors. Batteries may have much more stored energy than capacitors. For example, a lead acid battery might run a 6V, 3 A device for a couple of hours. A capacitor of similar cost to the battery might only be able to run that device for a few seconds before running out of energy. The capacitor alone would not be able to even do this without specially designed conversion circuitry that efficiently takes most of the usable energy in the capacitor and converts it into usable energy for the device.

In many cases, the remote monitoring or controlling functionality of the device preferably should be able to run indefinitely (without power interruption) for years without intervention or help from anyone. It must be able to do this with the only energy source to charge it, such as solar energy through a solar panel (photovoltaic). The product should achieve this through periods of darkness (due to nighttime and days of heavy cloud cover, rain, and snow). Likewise, another power consuming device attached to the capacitors should preferably be able to run at a constant energy draw for a finite amount of time each day in these same conditions. Consequently, there are significant design challenges in order to achieve this performance.

Returning now to FIG. 1, which also shows the connection of an external power source 20, which may be used in addition to the solar panel, or as an alternative method, for charging the capacitive network 12. The external power source 20 may include an external charger, batteries, solar panels, solar collectors, wind generators, wave action generators, electrolyzers, fuel cells, piezo electric films or elements or generators, AC/DC motors and generators and other power generation or storage devices.

Alternatively, a manual power source could be included such as, for example, oscillating a magnet through a coil of wire by shaking to generate electricity for charging the capacitor. More specifically, a hollow elongated barrel may be disposed within a housing, a wire coil wrapped around the barrel and disposed between the barrel and the housing, a magnet may be disposed within the barrel and sized to freely oscillate within the barrel when the barrel is shaken. In one embodiment, two springs are attached within the barrel and at either end of the barrel to cause the magnet to recoil when the magnet strikes the springs. The magnet oscillates within the barrel when the barrel is shaken, causing the magnet to pass back and forth through the wire coil, thereby causing current to flow within the coil and providing power to the capacitors.

Also, it is important to note that in many of the examples shown below, a DC-DC converter is included between the capacitors and the load. Those skilled in the art will realize that it will not always be necessary to include a DC-DC converter and in other cases other convertors or devices to accommodate the specific capacitor configuration and load requirements.

The remote monitoring or controlling functionality of the present invention may be accomplished in a variety of ways. For example, the remote monitoring or controlling functionality may be achieved through the use of a transmitter/receiver, transceiver, embedded wireless modules, a cellular phone, personal digital assistant or any other device used or useful in observing, monitoring or maintaining the condition of the device.

In one embodiment of the present invention, power can be provided to each of the devices using solar power coupled with capacitors. In other cases, it may be desirable to have certain functionality of each device to receive and maintain power, even when the power available in the capacitors is insufficient to power other functionality. For example, it may be important to keep the device's remote monitoring or controlling functionality powered, even though the device itself may not have sufficient power to operate.

In another embodiment, a power source, such as a solar panel, may be connected to one or more capacitors which provide power to the device. The device may contain a remote monitoring or controlling functionality to, for example, allow for remote monitoring of the device. In one embodiment, a first DC-DC converter provides a voltage to the remote monitoring or controlling functionality and a second DC-DC converter provides a voltage to the remaining features of the device. In this system, it is desired that the remote monitoring or controlling functionality remain powered at all times. If, for some reason, the capacitive network is completely drained after running the other features of the device, there will still be sufficient power stored in the capacitive network to maintain the remote monitoring or controlling functionality. Separate solar panels may be used to help ensure that there is plenty of energy available from sunlight during cloudy days to fully charge both capacitor banks. If desired, a battery could be used as a backup power source in the event that energy stored in the capacitors is depleted. A single solar panel and single capacitor bank could also be used to power the device. Various other methods of configuring the device with a power source, capacitors and remote monitoring or controlling functionality are described below and referenced in the Figures.

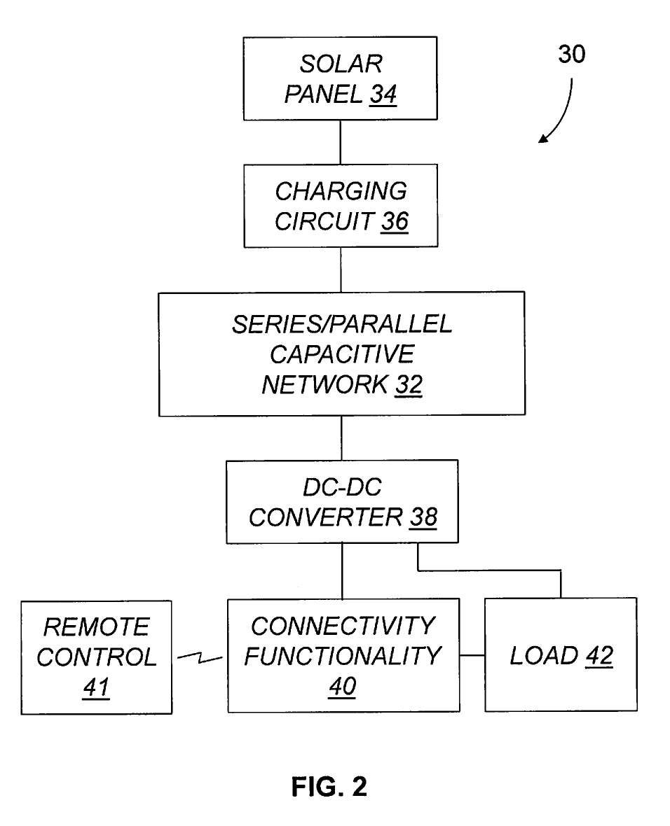

The power that is stored capacitively and provided to one or more loads in each of the foregoing devices and systems may be provided in a variety of ways. For example, FIG. 2 is a block diagram of one embodiment of system of the present invention. The system 30 includes a series/parallel capacitive network 32, such as the network described above. A solar panel 34 is used to charge the capacitive network 32, although any power source previously described could be used. A charging circuit 36 is used to control the charging of the capacitive network 32. A DC-DC converter 38 is used to step the capacitor voltage up or down to obtain a steady power supply for the device as the capacitor voltages drop. The DC-DC converter provides a voltage to both the connectivity functionality 40 and the load 42. FIG. 2 also shows a remote control 41 which is used to communicate with connectivity functionality 40.

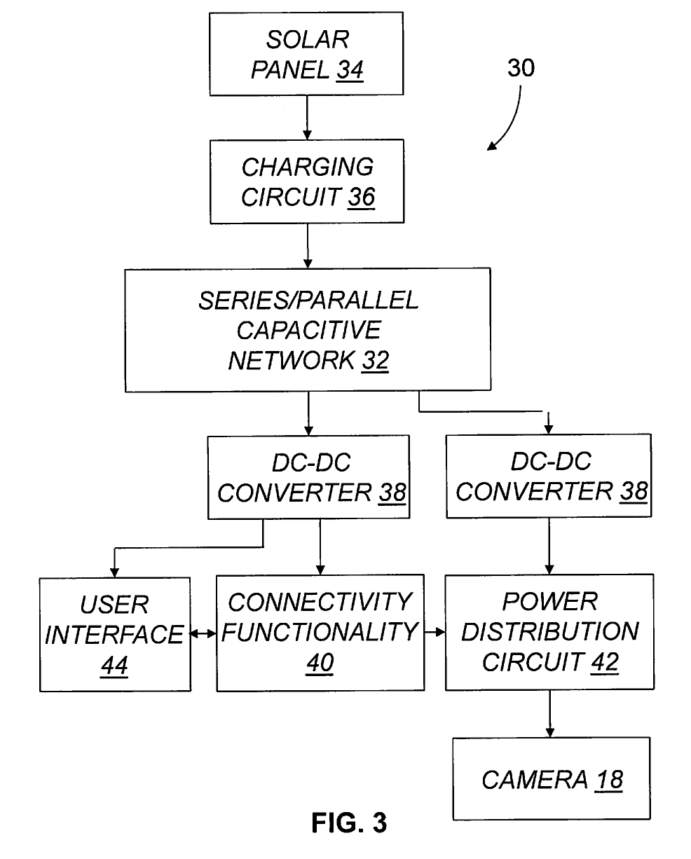

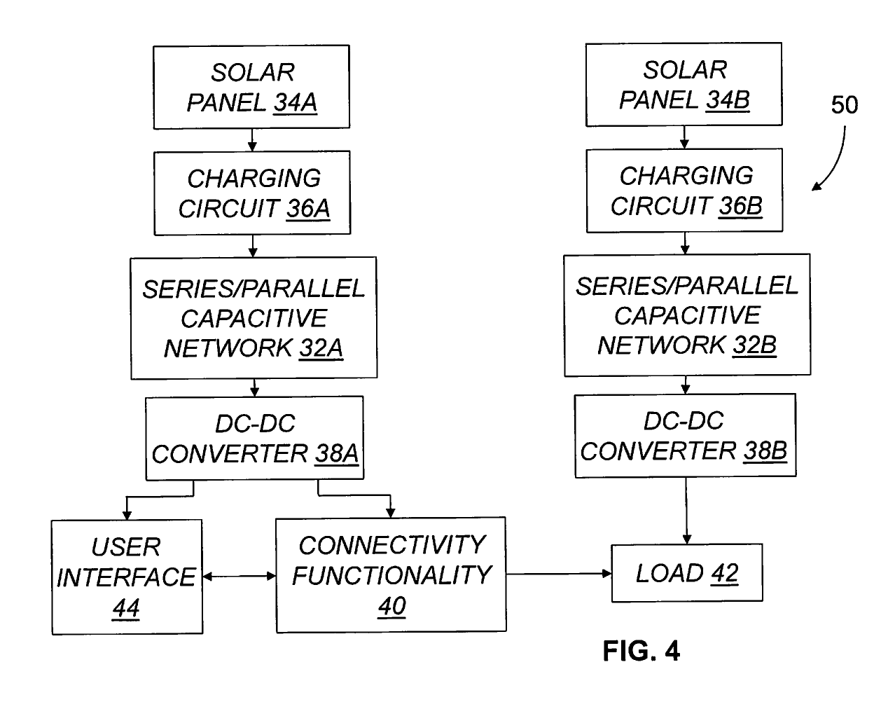

FIG. 3 is similar to the example shown in FIG. 2, except that a separate DC-DC converter is used by the load 42, which is a power distribution circuit. In this embodiment, the power distribution circuit provides power to connectivity functionality 40. FIG. 4 also shows a user interface block 44, which may include a display, lights, switches, keypad, etc., for use by a user to control the operation of the system 30.

FIG. 4 is a block diagram showing another embodiment of the system. FIG. 4 shows a block diagram of a system 50 that is similar to the system shown in FIG. 3, with separate capacitive networks and solar panels for the load and control circuitry. The system 50 includes first and second series/parallel capacitive networks 32A and 32B. First and second solar panels 34A and 34B are used to charge the capacitive networks 32A and 32B, respectively. Charging circuits 36A and 36B are used to control the charging of the capacitive networks 32A and 32B, respectively. A first DC-DC converter 38A provides a voltage to the timer/clock circuitry 40 and user interface 44. A second DC-DC converter 38B provides a voltage to the load. By separating the source of power to load and the control circuitry, the reliability of the system is increased. In many systems, it is desired that the timer remain powered at all times. If, for some reason, the capacitive network 32B is completely drained after running the load 42, there will still be sufficient power stored in capacitive network 32A to maintain the timers and clocks needed to maintain the desired operation of the system. Without this separation, the load 42 could rob the timer of needed energy. Separate solar panels help ensure that there is plenty of energy available from sunlight during cloudy days to fully charge both capacitor banks. If desired, with either embodiment, a battery could be used as a backup power source in the event that energy stored in the capacitors is depleted.

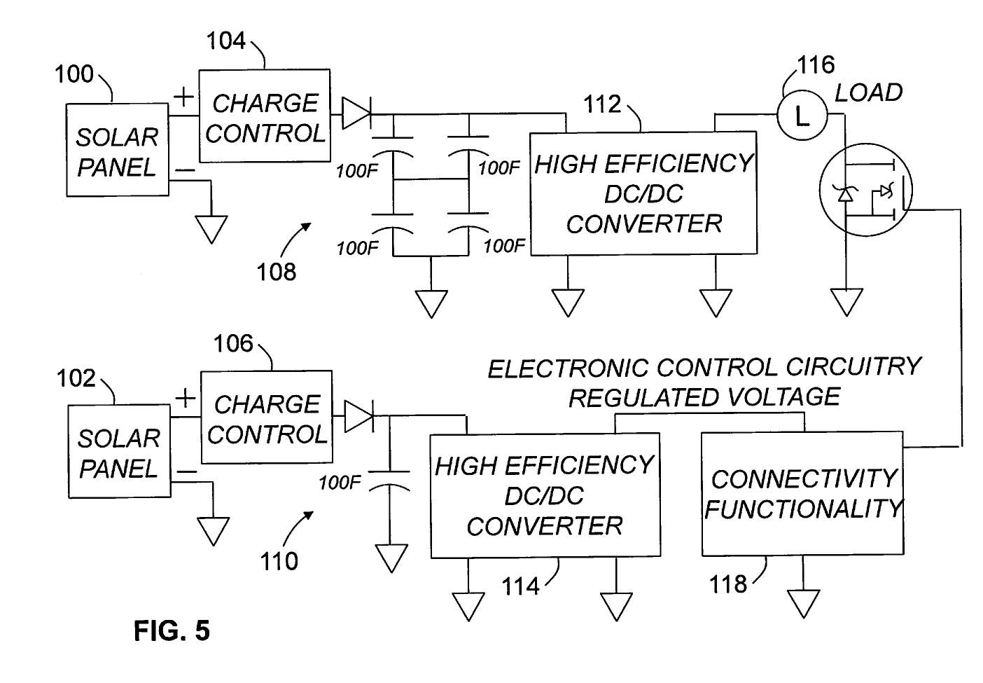

FIG. 5 is a block diagram illustrating circuitry for powering a load and for powering other circuitry using energy stored in capacitive networks. Like in FIG. 4, in the example shown in FIG. 5, separate solar panels and capacitive networks are used to power the load and other circuitry. FIG. 5 shows first and second solar panels 100 and 102 that provide power to charge control circuits 104 and 106, respectively. The solar panels 100 and 102 are ideally sized to provide enough charge (under low light) to run the motor or control circuitry for a desired time between charging periods. The charge control circuits 104 and 106 measures the capacitor charge voltage and protects the capacitors from charging to damaging voltage levels. The charge control circuits do this by shunting the solar panels output away from the capacitor(s) when the voltage reaches an ideal voltage (described in more detail below). The charge control circuits re-connect the solar panels when the capacitor voltage falls below the ideal voltage. In FIG. 5, the capacitive networks 108 and 110 are used to store solar energy collected during the daylight. At night or during low light level conditions, the capacitor networks provide enough energy to keep the clock and control circuitry powered (without interruption) until the solar panel can provide a recharge. As a result, the capacitor networks must be sized accordingly.

The DC-DC converter 112 converts the capacitor voltages to a usable voltage for the load 116. Similarly, DC-DC converter 114 converts the capacitor voltages to a usable voltage for the timer and connectivity functionality 118. The DC-DC converters 112 and 114 receive energy from both the solar panels 100 and 102 and capacitive networks 108 and 110 during daylight and from only the capacitive networks 108 and 110 during nighttime. The energy stored in the capacitive network 106 keeps the control circuitry powered indefinitely by using most of the available energy in the capacitors (even down to low voltages). The DC-DC converter 112 also provides a regulated voltage output at the appropriate level for a given load. The connectivity functionality 118 may include an LCD display for showing the time of day and the programming of times at which power is provided to the load. The connectivity functionality 118 also may include a user interface for the user to customize the operation of the system.

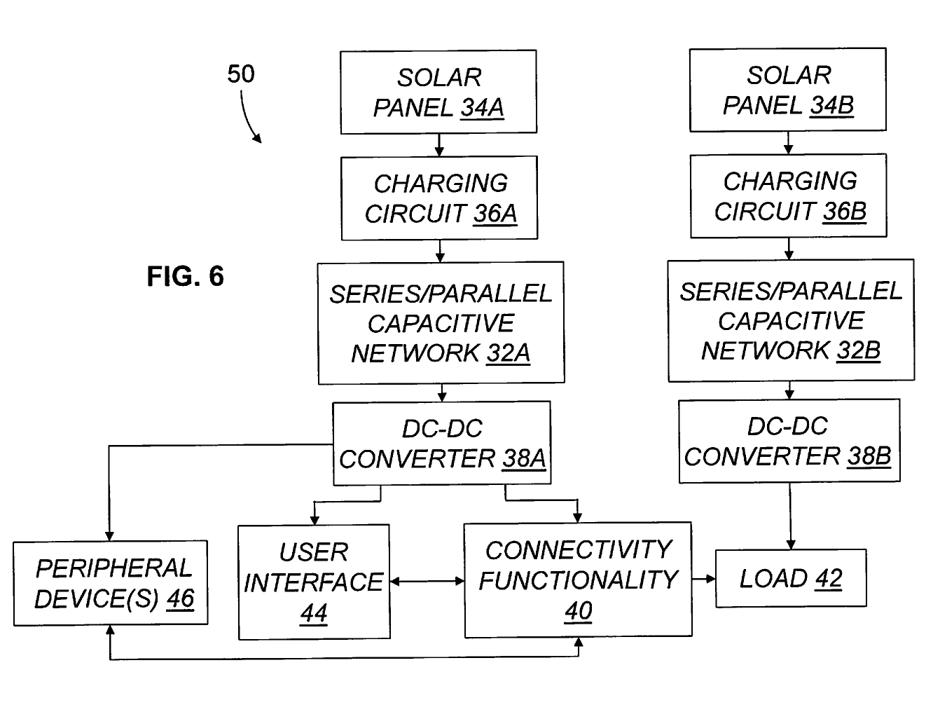

FIG. 6 is a block diagram illustrating another embodiment of the present invention. FIG. 6 is similar to FIG. 4, with the addition of a peripheral device 46. A peripheral device 46 can be powered in the same manner as the connectivity functionality 40. A peripheral device can be controlled by the connectivity functionality 40, or by any other desired manner. The peripheral device 46 may be comprised of any desired device that can work with a capacitively powered system.

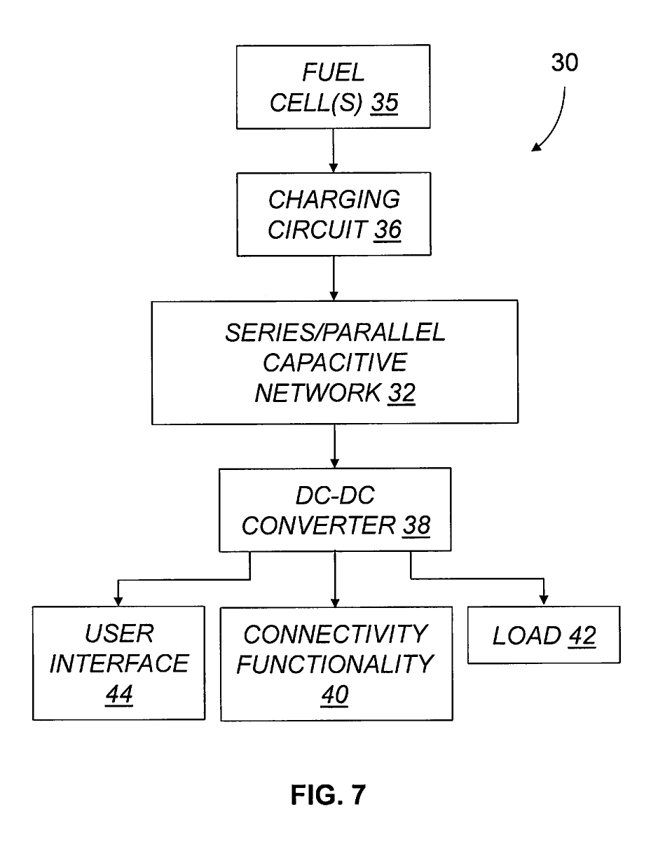

FIG. 7 is a block diagram illustrating another embodiment of the present invention. In the embodiment shown in FIG. 7, the capacitive network 32 is charged using a fuel cell 35. One advantage of this embodiment is that the power to the system is not dependent on sunlight. One disadvantage, compared to using a solar panel, is that a fuel storage device will have to be periodically replenished by a user. In another embodiment, a system can use both solar panels and a fuel cell to provide power to the capacitive network 32. Other embodiments are also possible. For example, a wind generator or other power source described above could be used as a source of energy to charge the capacitive network.

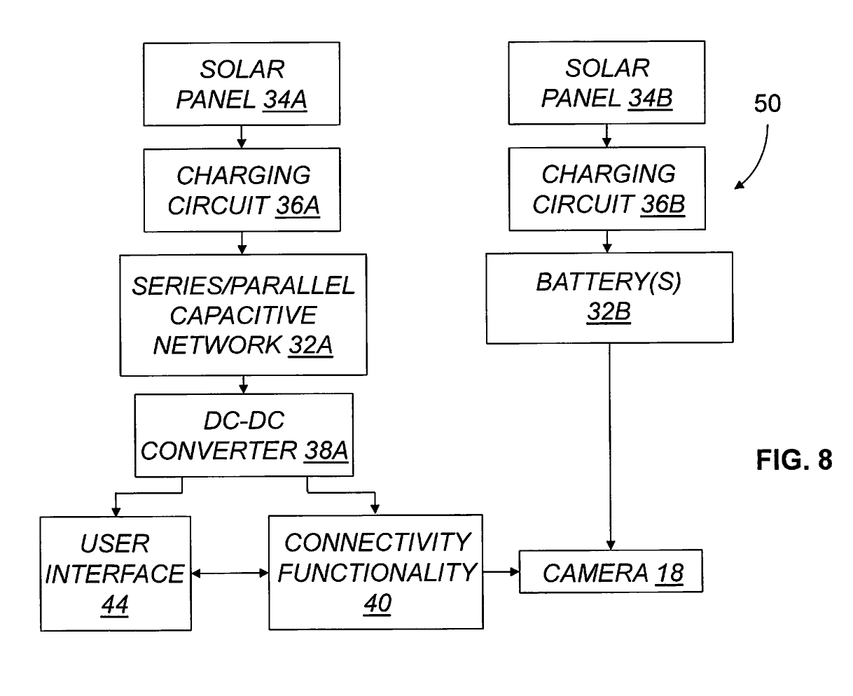

FIG. 8 is a block diagram showing another embodiment of a system with an access point, router or other load. FIG. 8 shows a block diagram of a system 50 that is similar to the systems described above, with a capacitive network for the DC-DC converter, user interface, and timer/clock circuitry. A second solar panel and charging circuit supplies power to battery 32B, which provide power to the access point, router or other load 18.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible remotely controlled and monitored devices available, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

We claim:

1. A method of operating a device comprising:
providing one or more solar panels;
storing energy from the one or more solar panels in one or more capacitors;
providing connectivity functionality operatively coupled to the device and to the one or more capacitors;
using the energy stored in the one or more capacitors to provide power to the device; and
preventing the device from depleting energy stored in the one or more capacitors below a critical level so that the connectivity functionality will have enough energy available to sustain operation during time periods when the energy stored in the one or more capacitors is insufficient to maintain operation of both the connectivity functionality and other device functionality during a period of time in which there may be limited amounts of solar energy for charging the capacitors back to a fully operational level.

2. The method of claim 1, wherein the connectivity functionality is a transceiver.

3. The method of claim 1, wherein the connectivity comprises an RF transmitter and receiver.

4. The method of claim 1, wherein the connectivity functionality comprises a device for transmitting on a wireless network.

5. The method of claim 1, wherein the charging of the one or more capacitors is at least partially disabled when the voltage of the one or more capacitors reaches a threshold voltage.

6. The method of claim 1, wherein the device is powered without using power from a non-photovoltaic power source such as a chemical battery.

7. The method of claim 1, further comprising using a DC-DC converter to step the capacitor voltage up or down to provide a desired steady voltage level to the device, even as the capacitor voltages fall.

8. The method of claim 1, wherein the control circuitry is programmable by a user to activate the device at predetermined intervals and durations.

9. The method of claim 1, wherein the one or more capacitors comprises first and second separate capacitive networks, wherein the first capacitive network provides power to the control circuitry, and the second capacitive network provides power to the device.
